(19) United States
(12) Patent Application Publication
(10) Pub. No.: US 2004/0114753 A1
(43) Pub. Date: Jun. 17, 2004

(54) Cover assembly of mobile phone

(76) Inventors: Xiaozhou Wang, Shenzhen (CN); Jiang Yuan He, Shenzhen (CN); Chia-Hua Chen, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/342,779

(22) Filed: Jan. 14, 2003

(30) Foreign Application Priority Data
Dec. 13, 2002 (TW) 91220207

(51) Int. Cl. H04M 1/00; H04M 9/00

(52) U.S. Cl. 379/419; 379/428.01

(57) ABSTRACT

A cover assembly (1) of a mobile phone includes a front cover (2) and a back cover (3). The front cover defines a front microphone cavity (4) at an end thereof with at least one opening formed in a wall of said front microphone cavity. The back cover defines a back microphone cavity (5) at an end thereof, corresponding in position to that of the front microphone cavity in the front cover. At least one opening is formed in a wall of said back microphone cavity. Said front and back covers are assembled together to form the cover assembly, resulting in a combination of said front and back cavities to create a combined microphone cavity (90) for receiving a microphone (70) therein, the combined cavity having at least one aperture (46) at its lower end, thereby improving voice quality and structural integrity of the mobile phone.

### FIELD OF THE INVENTION

The present invention relates to cover assemblies of portable electronic devices, and particularly to cover assemblies of mobile phones with microphone chambers.

### BACKGROUND OF THE INVENTION

In recent years, mobile phones have become increasingly popular for both personal and commercial use. This increase in popularity has generated an increase in demand for better voice quality and stronger cover assemblies for mobile phones. An important factor influencing both voice quality and housing strength of mobile phones is a design of a microphone chamber in a cover assembly.

U.S. Pat. No. 5,867,772 discloses a cover assembly comprising a front cover and a back cover. A microphone is mounted directly behind a grille of the front cover of the cover assembly. Because the cover assembly thereof has no additional configuration for protecting the microphone, the microphone is easily damaged. In addition, since the cover assembly lacks of a configuration to channel voice signals, the voice signals from an exterior will dissipate in all directions, consequently resulting in lesser quality voice transmission than are possible in the mobile phone channels voice signals.

To overcome the above-mentioned problems, U.S. Pat. No. 6,006,118 illustrates an improved cover assembly of a mobile phone. Said cover assembly comprises a front cover and a back cover. A slot is defined in the front cover to receive a microphone therein. However, because the slot of the cover assembly is not an enclosing structure, it cannot provide total protection for the microphone and a potential danger of damage to the microphone still exists. In addition, the cover assembly also has a drawback in that it cannot collect voice signals efficiently so the voice signals still dissipate as before and a proper resonance will not result. Thus, the voice quality of the mobile phone is unsatisfactory. Furthermore, the cover assembly cannot firmly fix the microphone therewithin so the microphone can therefore rock relative to the cover assembly during use of the mobile phone. Also, the slot of the cover assembly is positioned at a lower end of a manipulating panel of the front cover, and can easily to collect noises produced by breathing or panting.

Therefore, an improved cover assembly of a mobile phone is desired to overcome the disadvantages of the prior art.

### SUMMARY OF THE INVENTION

A main object of the present invention is to provide a mobile phone cover assembly of which can improve voice quality transmitted during communication.

Another object of the present invention is to provide a mobile phone cover assembly which firmly fixes a microphone therein and thereby prevents the microphone from being damaged or rocking.

To achieve the above objects, a cover assembly of a mobile phone comprises a front cover and a back cover. The front cover defines a front cavity at an end thereof and at least one opening formed in said front cavity. The back cover defines a back cavity at an end thereof corresponding in position to the front cavity of the front cover, the back cavity having at least one opening formed in a wall of said back cavity. Said front and back covers are assembled together to form the cover assembly providing a combined cavity formed from a union of the front and back cavities. The combined cavity has at least one aperture at its lower end and receives a microphone therein, thereby improving transmitted voice quality and providing a stronger structure of the mobile phone.

Other objects, advantages and novel features of the invention will become more apparent from the following detailed description of a preferred embodiment thereof when taken in conjunction with the accompanying drawings, wherein:

### BRIEF DESCRIPTION OF THE DRAWINGS

FIG. 1 is a partially disassembled, perspective view of a cover assembly of a mobile phone in accordance with a preferred embodiment of the present invention;

FIG. 2 is an enlarged, schematic view of a disassembled microphone cavity of the cover assembly of FIG. 1;

FIG. 3 is an assembled view of the microphone cavity of FIG. 2; and

FIG. 4 is a partial, perspective view of a front cover of the cover assembly of FIG. 1 with a microphone assembled therein.

### DETAILED DESCRIPTION OF THE INVENTION

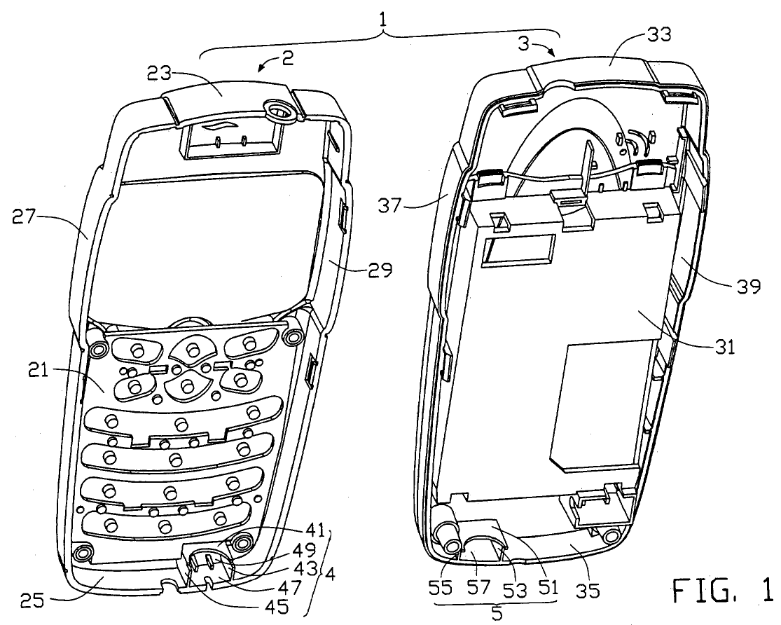

Referring now to the drawings in detail, FIG. 1 shows a cover assembly 1 of a mobile phone in accordance with a preferred embodiment of the present invention. The cover assembly 1 comprises a front cover 2 and a back cover 3.

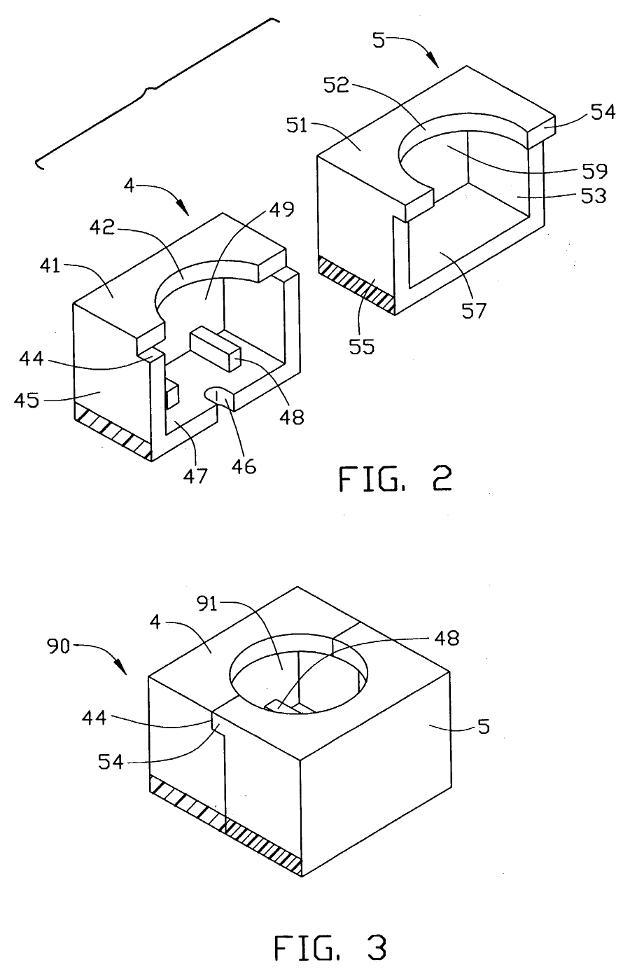

The front cover 2 comprises a manipulating panel 21 and four lateral walls 23, 25, 27, 29 extending from the manipulating panel 21. A front microphone cavity 4 is formed in a lower end of the front cover 2 and is defined by a bottom plate 49 and four lateral plates 41, 43, 45, 47 extending therefrom. As best shown in FIG. 2, the lateral plate 41 has an arc-shaped opening 42 in an end thereof, and the lateral plate 47 forms an aperture 46 therein for receiving voice signals from an exterior. Two stoppers 48 are formed on the lateral plate 47 and extend to the bottom plate 49. In the present invention, the vertical lengths of the three lateral plates 43, 45, 47 are larger than the lateral plate 41 so that a pair of breaches 44 is defined at two lateral sides of the opening 42.

Still referring to FIG. 1, the back cover 3 comprises a bottom wall 31 and four lateral walls 33, 35, 37, 39 extending from the bottom wall 31. A back microphone cavity 5 is defined in a lower end of the back cover 2 corresponding to the front microphone cavity 4 and is defined by a bottom plate 59 (see FIG. 2) and four lateral plates 51, 53, 55, 57 extending therefrom. As is best shown in FIG. 2, the lateral plate 51 has a semicircular opening 52 in a far end thereof from the bottom plate 59. In the present invention, the vertical lengths of the three lateral plates 53, 55, 57 are smaller than the lateral plate 51 so that a pair of tabs 54 extends from the lateral plate 51 at two lateral sides of the opening 52.

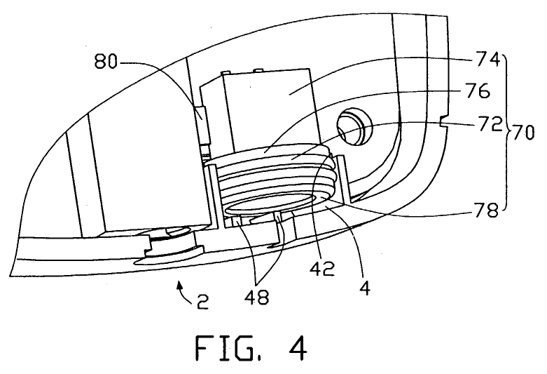

As shown in FIGS. 3 and 4, during assembly, firstly, a microphone 70 is positioned in the front microphone cavity 4 of the front cover 2, wherein the microphone 70 has a head portion 72 and a tail portion 74 electrically connecting with a printed circuit board 80. The head portion 72 has a base 76 interposed between the head portion 72 and the tail portion 74. The opening 42 engages with said base 76, and the two stoppers 48 support and secure a bottom portion 78, thereby preliminarily fixing the microphone 70 in the front cover 2. Then, the back cover 3 (see FIG.1) is combined with the front cover 2. Accordingly, the pair of breaches 44 engages with the tabs 54 and the back microphone cavity 5 and the front microphone cavity together define a combined microphone cavity 90 which encloses the microphone 70 therein. In the embodiment shown, the microphone cavity 90 defines a circular opening 91 by which a circumference of the base 76 is engaged. Thus the microphone 70 more securely fixed, and is prevented from rocking or being damage.

The microphone cavity 90 formed by the assembly of the front and back covers 2, 3, receives voice signals from an exterior via the aperture 46, which results in an increased intensity of the voice signals sensed by the microphone 70. This configuration of the microphone cavity 90 also creates a sound box creating a resonance of the voice signals transmitted into the microphone cavity 90 and input into the microphone 70. The result is improved voice quality during communication. Furthermore, because the aperture 46 is defined in the lateral wall 25 and not in a low end of the manipulating panel 21, as featured shown in prior arts, it is obvious that noises produced by breathing or panting and transmitted into the microphone cavity 90 and then the microphone 70, are reduced.

It will be apparent that many changes and modifications of the several features described herein may be made without departing from the spirit and scope of the invention. It is therefore apparent that the foregoing description is by way of illustration of the invention rather than limitation of the invention.

What is claimed is:

1. A cover assembly of a portable electronic device comprising:
a front cover defining a front microphone cavity at an end thereof and at least one opening formed in a wall of said front cavity;
a back cover defining a back microphone cavity at an end thereof corresponding in position to that of the front microphone cavity in the front cover, with at least one opening formed in a wall of said back microphone cavity;
wherein, at least one aperture is formed either or both the front and back covers, the at least one aperture communicating with the corresponding microphone cavity when said front and back covers are assembled together to form the cover assembly, the front and back microphone cavities together define a combined microphone cavity to receive a microphone therein and the combined microphone cavity has at least one aperture at its lower end, by a combination of said front and back cavities, thereby improving voice quality transmitted during communication and providing a stronger structure of the mobile phone.

2. The cover assembly as claimed in claim 1, wherein at least one stopper is provided in said front cavity of the front cover to support and fix said microphone.

3. The cover assembly as claimed in claim 2, wherein said combined microphone cavity has an opening to engage with the microphone.

4. The cover assembly as claimed in claim 3, wherein said front microphone cavity combines with the back microphone cavity using a complimentary coupling structure.

5. The cover assembly as claimed in claim 1, wherein the portable electronic device is a mobile phone.

6. The cover assembly as claimed in claim 5, wherein the front microphone cavity is defined by a bottom plate and four lateral plates extending therefrom, and the back microphone cavity is defined by a bottom wall and four lateral walls extending from the bottom wall.

7. The cover assembly as claimed in claim 6, wherein one of the lateral plates of the front microphone cavity has an arc-shaped opening in an end thereof, and another of the lateral plates forms an aperture therein for receiving voice signals from an exterior.

8. The cover assembly as claimed in claim 7, wherein two stoppers are formed on the lateral plate with the aperture and extend to the bottom plate.

9. The cover assembly as claimed in claim 8, wherein the vertical lengths of the other three lateral plates are larger than the lateral plate with the arc-shaped opening so that a pair of breaches is defined at two lateral sides of the opening.

10. The cover assembly as claimed in claim 5, wherein the back microphone cavity is defined by a bottom plate and four lateral plates extending from the bottom plate.

11. The cover assembly as claimed in claim 10, wherein one of the lateral plates of the back microphone cavity has a semicircular opening in a far end thereof from the bottom plate thereof.

12. The cover assembly as claimed in claim 11, wherein the vertical lengths of the other three lateral plates are smaller than the lateral plate with the semicircular opening so that a pair of tabs extends therefrom at two lateral sides of the semicircular opening.

13. A subassembly of a mobile phone comprising:
a cover assembly having a front cover and a back cover, wherein the cover assembly defines a microphone cavity having at least one aperture, said microphone cavity being formed by combination of said front and back covers;
a microphone electrically connecting with a printed circuit board and being received in said microphone cavity.

14. The subassembly of a mobile phone as claimed in claim 13, wherein the microphone has a head portion and a tail portion; and the head portion has a base interposed between the head portion and the tail portion.

15. The subassembly of a mobile phone as claimed in claim 14, wherein at least one stopper is provided in said microphone cavity of the cover assembly to support and fix said microphone.

16. The subassembly of a mobile phone as claimed in claim 15, wherein said microphone cavity has an opening to engage with the microphone.

17. The cover assembly as claimed in claim 16, wherein said microphone cavity is formed by a combination of a front microphone cavity of the front cover with a back microphone cavity of the back cover.

18. A mobile phone comprising:
a cover including upper and bottom halves assembled together;
an outer peripheral wall formed by cooperation of said upper and bottom halves to define a space for receiving a printed circuit board and associated electronic components therein; and
an inner peripheral wall formed by at least one of said upper and bottom halves inside said outer peripheral wall, and defining a cavity for receiving a voice transmission device; wherein
said inner peripheral wall is dimensioned and configured to not only snugly hold said voice transmission device in said cavity, but also provide guidance of voice so as to have voice efficiently transmitted.

19. The phone as claimed in claim 18, wherein said cavity communicates with an exterior via an opening in one direction.

20. The phone as claimed in claim 19, wherein said opening is formed in said outer peripheral wall.
